(19) United States
(12) Patent Application Publication
(10) Pub. No.: US 2020/0184407 A1
(43) Pub. Date: Jun. 11, 2020

(54) TELECOMMUNICATION NETWORK CUSTOMER PREMISES SERVICE SCHEDULING OPTIMIZATION

(71) Applicant: AT&T Intellectual Property I, L.P., Atlanta, GA (US)

(72) Inventors: Rudolph Mappus, Plano, TX (US); Tejas Antani, Carrollton, TX (US); Quan Nguyen, McKinney, TX (US); Erian Laperi, Frisco, TX (US); Mark D. Austin, Allen, TX (US); Abhay Dabholkar, Allen, TX (US)

(21) Appl. No.: 16/215,450

(22) Filed: Dec. 10, 2018

(51) Int. Cl. G06Q 10/06; G06Q 10/04; G06N 20/00

(52) U.S. Cl. CPC G06Q 10/063116; G06N 20/00; G06Q 10/047

(57) ABSTRACT

A processing system may obtain a request for a new assignment for field technician work associated with a customer premises of a telecommunication network and generate a hypothetical schedule for a future date for field technicians from a set of scheduled assignments in accordance with first optimization factors, the hypothetical schedule including bundles of scheduled assignments for field technician work, each bundle including scheduled assignments for an individual field technician for the future date. The processing system may then determine opportunity windows for scheduling the new assignment comprising time blocks for which individual field technicians are not scheduled to work one of the scheduled assignments in a respective bundle in accordance with the hypothetical schedule, rank the opportunity windows in accordance with second optimization factors, and provide to a customer associated with the customer premises, an offer of an opportunity window, the offer including a rank of the opportunity window.

The present disclosure relates generally to telecommunication network maintenance and provisioning, and more particularly to methods, computer-readable media, and devices for determining a plurality of opportunity windows for scheduling a new assignment for field technician work associated with a customer premises of a telecommunication network.

### BACKGROUND

In a telecommunication network, the plant (e.g., the wires and equipment that carry customer services) conditions may change from area to area. For instance, in some places, the telecommunication network may be operating at or near capacity, and to add a new customer, new equipment may be provisioned and installed before adding the new customer service. As a result, some installation jobs may include an additional technician dispatch for network-side work to be completed before finishing the installation job with work at the customer premises.

### SUMMARY

In one example, the present disclosure provides a method, computer-readable medium, and device for determining a plurality of opportunity windows for scheduling a new assignment for field technician work associated with a customer premises of a telecommunication network. For example, a method may include a processing system having at least one processor obtaining a request for a new assignment for field technician work associated with a customer premises of a telecommunication network and generating a hypothetical schedule for a future date for a plurality of field technicians from a set of scheduled assignments, where the hypothetical schedule includes a plurality of bundles of scheduled assignments for field technician work for the plurality of field technicians, where each bundle includes a plurality of scheduled assignments for an individual field technician of the plurality of field technicians for the future date, and where the hypothetical schedule is generated in accordance with a first plurality of optimization factors. The processing system may then determine a plurality of opportunity windows for scheduling the new assignment, where the plurality of opportunity windows comprises time blocks during the future date for which individual field technicians of the plurality of field technicians are not scheduled to work one of the plurality of scheduled assignments in a respective bundle of the plurality of bundles in accordance with the hypothetical schedule for the future date. The processing system next may rank the plurality of opportunity windows in accordance with a second plurality of optimization factors, and provide to a customer associated with the customer premises an offer of at least one of the plurality of opportunity windows, where the offer includes at least one rank of the at least one of the plurality of opportunity windows.

### BRIEF DESCRIPTION OF THE DRAWINGS

The present disclosure can be readily understood by considering the following detailed description in conjunction with the accompanying drawings, in which:

FIG. 1 illustrates one example of a system including a telecommunication network, according to the present disclosure;

FIG. 2 illustrates a flowchart of an example method for determining a plurality of opportunity windows for scheduling a new assignment for field technician work associated with a customer premises of a telecommunication network; and

FIG. 3 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable media, and devices for determining a plurality of opportunity windows for scheduling a new assignment for field technician work associated with a customer premises of a telecommunication network. For instance, in telecommunication network operations, customer assignments (e.g., work performed at customer premises and/or at other network locations in connection with network service to customer premises) can often be spatially proximate but end up being scheduled on different days. The present disclosure implements an intelligent “look ahead” of the current list of (pending) customer assignments and offers availability to a customer for a new customer assignment that meets the customer's demands while simultaneously optimizing for the telecommunication network operator preferences. For example, the present disclosure applies a heuristic optimization method to find optimal opportunity windows (time windows) to offer to a customer such that the daily schedules of field technicians are efficient while also meeting the customer's preferences. In one example, the heuristic optimization scores availability windows based on current job data and historical data about jobs in the area. The ranked availability is presented to the user for scheduling. The present disclosure may also recommend incentives for customers to select time windows based on previous customers' selections for similar customer appointments.

To illustrate, in one example, the present disclosure may first estimate customer assignment durations using historical customer assignment data and estimate the number of available field technicians for a plurality of future dates. When a new customer appointment is ready to be scheduled, the present disclosure may generate a hypothetical schedule for the estimated number of field technicians in the area to work the currently booked appointments via a heuristic optimization solver, obtain customer preference(s) for scheduling the new appointment, identify candidate time windows (windows of opportunity) for the new customer appointment based upon the hypothetical schedule, rank the opportunity windows in accordance with the customer's preference(s) and network operator preferences, and return a prioritized list of opportunity windows. The rank may be a score for how well the opportunity window satisfies the preference(s) (e.g., a multi-factor ranking in accordance with the preferences, and weights selected for the respective preferences, where the weights may be selected by a field technician dispatch supervisor, or the like).

In order to generate a hypothetical schedule for a future date, the present disclosure may first estimate how long each customer appointment (e.g., those already scheduled) will take. However, it should be noted that in one example, a scheduled customer appointment is not necessarily linked to a specific field technician that will work the customer appointment unit the day actually arrives. In one example, the customer appointment duration estimates are generated offline, in advance of the scheduling task. The present disclosure uses data from previously completed work in the area for each job type and technician to estimate the duration of jobs in areas. For example, the present disclosure may collect the time windows, appointment locations, completion rates, appointment/job durations, maintenance and install rates, and so forth. In one example, a gradient boosted machine is used to regress features about the customer appointments to the customer appointment completion durations.

For example, the present disclosure may create a prediction model, e.g., a gradient boosted machine, for predicting the duration of a future customer appointment. In one example, the present disclosure trains the prediction model using data (features) that may be indicative of the duration of a customer assignment. The features may broadly fall into three categories of: job feature data, calendar feature data, and time series feature data. Examples of job feature data include: broad category of work, code for types of install work, code for the type of service being installed, code for the type of network used to deliver services, codes for the geography associated with a customer appointment (including wire center identification, city, state, postal code, Common Language Location Identifier (CLLI), latitude, longitude, etc.), details about the specific work to be assigned (e.g., duration, priority, job category, source type, job type, etc.), details of the work status (e.g., assigned, pending, dispatched, cancelled, or completed), due dates and access features, and so forth.

Examples of calendar feature data include: a number of a week in a month, a day of a week number, a Boolean value indicating a holiday, a Boolean value indicating a national holiday, a Boolean value indicating a weekday or a weekend, and so on. Examples of time series data include: moving averages of completion times for job types (customer appointment types) in an area (e.g., 7, 14, 30, 60, and 90-day moving averages, and so forth), counts of completed jobs for job types in the area (e.g., 7, 14, 30, 60, and 90-day counts), moving averages of completion types by job type and per network aggregation point (e.g., 7, 14, 30, 60, and 90-day moving averages per class 5 central office (CO), per digital subscriber line access multiplexer (DSLAM), or the like), counts of completed jobs for job types per network aggregation point (e.g., 7, 14, 30, 60, and 90-day counts), a count of a number of helper jobs per job type per network aggregation point (e.g., whether a customer appointment required additional network-side work), a rolling sum of the count of helper jobs per job type per network aggregation point.

In one example, the prediction model is a linear function of these feature values, and the weights for each feature may be learned by the prediction model (e.g., a gradient boosted machine). The present disclosure may then use the output of the linear function from new input data relating to each of the customer appointments (as the customer appointments are added to a set of scheduled appointments) to predict the duration of the customer appointment (how long it will take a field technician to complete the work).

The present disclosure also estimates the daily available capacity (how many field technicians are available) on a future date in the relevant area where the work will occur. For instance, the scheduling optimization of the present disclosure may be performed on a per-work center basis (e.g., per regional office, such as a class 3 office, a class 4 and/or class 5 central office (CO), etc. to which a number of field technicians are assigned as a home office/work center). In this regard, the present disclosure may use historical data about the network technicians associated with the area and their availability each day (attendance and performance) to estimate available field technicians in the area for each day in a future appointment horizon (e.g., up to 30 days, up to 60 days, etc.). In one example, the present disclosure uses a gradient boosted machine to estimate field technician availability for the future days in a work area. For instance, the gradient boosted machine may regress features about historical field technician work history information to the actual number of technicians working each day. Historical field technician work history information may include: a day of the year, a mean number of field technicians working in an area, a number of field technicians scheduled to work on the day, an actual number of field technicians working on the day, a month, a week of the month, a day of the week, a Boolean value indicating a holiday, a Boolean value indicating a national holiday, a Boolean value indicating a weekday or a weekend, and so on.

When booking a new customer appointment, the present disclosure first uses the set of scheduled customer appointments for a future date and their estimated durations, and the estimated number of available technicians for the future date as inputs to generate a hypothetical schedule for the future date. In one example, the present disclosure generates and solves a heuristic optimization problem to identify which appointments may be grouped or bundled together for a field technician to work for a day, where each “bundle” may be assigned to a different field technician. In other words, each bundle includes a plurality of scheduled assignments for an individual field technician of the plurality of field technicians for the future date.

In one example, the overall scheduling (for the anticipated number of available field technicians) is optimized for several objective criteria, such as: a preference to assign all scheduled assignments to available field technicians, a preference to use as few field technicians as possible, a preference to have individual field technicians work at most a designated number of hours in a day (e.g., eight hours, seven hours, nine hours, etc.), a preference to minimize driving distances by the plurality of field technicians, and/or a preference to maximize a number of jobs completed per technician per day. For instance, the present disclosure may attempt to group customer appointments into “bundles” based upon geographic and network proximity, and then assign bundles to individual field technicians (e.g., for a single day of work). Alternatively, or in addition, an objective may be to balance work among the estimated number of available field technicians instead of minimizing the number of field technicians assigned customer appointments.

In addition to a current set of scheduled customer appointments and the estimated number of field technicians available, the present disclosure may also account for a distance matrix, e.g., point-to-point distances between each scheduled customer assignment and each potential technician's location, e.g., the technician's home. In one example, the customer appointments may further be grouped by work type, network type, or the like. For instance, there may be certain classes or types of field technicians with the training, expertise, and/or tools to perform certain types of work, while other field technicians are not so equipped, or who may be equipped to perform other, further, and different types of work for different types of customer assignments. Using all of this information and constraints, the present disclosure determines potential solutions to the optimization problem via an optimization solver (e.g., a linear optimization solver, a constrained linear optimization solver, etc.). By pre-scheduling and then dispatching field technicians to address several customer appointments on a single workday, the field technician's time is efficiently utilized in addition to saving travel time, fuel usage, and so forth. It is again noted that customer assignments may be bundled without actual assignment of the bundle to a specific field technician of a particular class of technicians until the day of.

The solution of the optimization is a hypothetical schedule for the estimated number of field technicians for the future date. However, not all of the bundles may be complete. In other words, the work for an individual field technician for the day may have gaps or time windows during which no work is scheduled (and which may be more than sufficient for the field technician to travel from an earlier customer assignment to the next scheduled customer assignment). These gaps, or time windows, may comprise opportunity windows during which a new customer assignment may be scheduled.

The present disclosure assembles these opportunity windows and then applies a heuristic optimization to solve a secondary optimization problem: searching the space of opportunity windows to find the best opportunity window(s)/time slots according to a plurality of optimization factors, such as: a time between a preceding customer appointment in a bundle and the candidate opportunity window, a time between the anticipated end of the new customer appointment (if assigned to the opportunity window) and a succeeding scheduled customer appointment in a bundle, a proximity of a location of the new customer appointment to an anticipated location of a field technician assigned the bundle (e.g., a location of a previous customer appointment in the bundle), a lowest probability of needing a helper (additional work), customer preference(s), a minimal number of technicians to complete the work using a minimal amount of drive time, etc. It should be noted that the anticipated end of the new customer appointment may be estimated in the same manner described above, e.g., via a trained gradient boosted machine which takes various job feature data, calendar feature data, and time series feature data as inputs, and outputs an estimated duration of the customer appointment.

In one example, the present disclosure may use previous time window selections for similar customer appointments and/or similar customers to produce the score. For instance, the present disclosure may learn the importance of each optimization factor, or “prioritization item,” by tracking historic success rates of historic scheduled customer appointments, and predicting a success likelihood of a future customer appointment scheduled in the opportunity window. In addition, the present disclosure uses logistic regression and historical jobs customer appointment scheduling information to estimate success probabilities for new customer appointments, where the objective label for each historic customer appointment is a success (job completed in the assigned time slot with no defects or repeats) or a failure. The learned linear model then provides weights (coefficients) for each variable. The output prioritized list is ordered by the candidate window scores. In under-constrained conditions, the model may prefer earlier appointments to later appointments. In other words, in cases where capacity is much greater than the scheduled work (i.e., there are more opportunities to evaluate than what can be offered to the customer), the present disclosure prefers to schedule work earlier in the day than later.

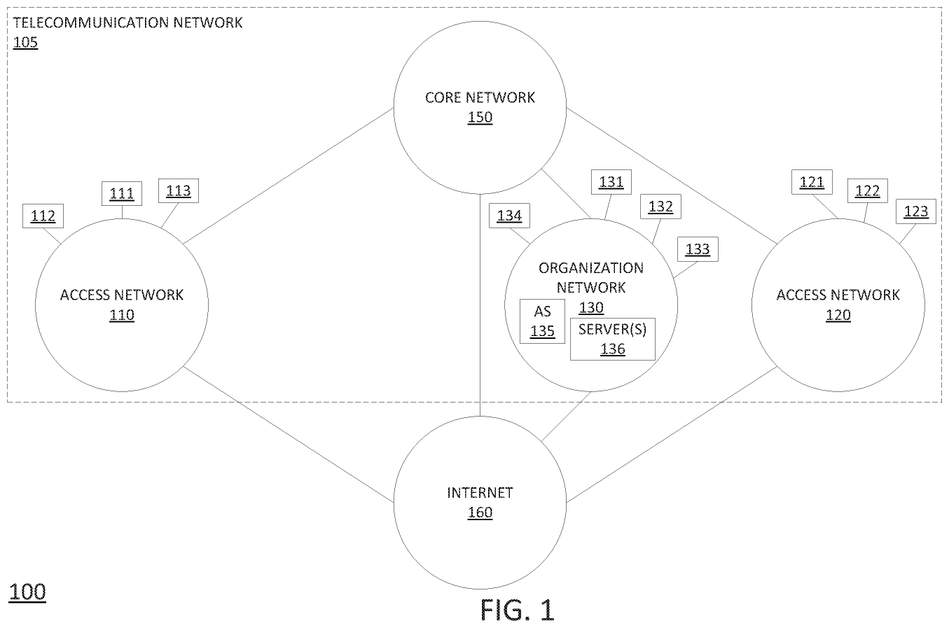

In addition to the existing work schedule (e.g., the “hypothetical schedule”), the solution space of possible time windows to assign the new customer appointment is subject to the time horizon to search (how many days in the future to consider scheduling the work). The tradeoff of the optimization balances the time horizon and the quality of the schedule. As the time horizon increases, the likelihood of customer appointments changing or canceling increases. As the time horizon decreases, the likelihood of customer appointments changing decreases. In one example, the present disclosure may also determine if an incentive should be offered to the customer to accept a preferred/recommended opportunity window. Thus, in accordance with the present disclosure, field technicians are better able to reach customer appointments on time. In addition, customers are offered better choices for appointment bookings. Being able to optimize offerings for the field technicians also enables increased technician job completion rates. These and other aspects of the present disclosure are discussed in greater detail below in connection with the examples of FIGS. 1-3.

FIG. 1 illustrates an example system 100 comprising a plurality of different networks for supporting examples of the present disclosure for determining a plurality of opportunity windows for scheduling a new assignment for field technician work associated with a customer premises of a telecommunication network. Telecommunication network 105 may comprise a core network 150 with components for telephone services, Internet services, and/or television services (e.g., triple-play services, etc.) that are provided to customers (broadly “subscribers”), and to peer networks. In one example, core network 150 may combine core network components of a cellular network with components of a triple-play service network. For example, core network 150 may functionally comprise a fixed mobile convergence (FMC) network, e.g., an IP Multimedia Subsystem (IMS) network. In addition, core network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 150 may also further comprise a broadcast television network, e.g., a traditional cable provider network or an Internet Protocol Television (IPTV) network, as well as an Internet Service Provider (ISP) network. With respect to television service provider functions, core network 150 may include one or more television servers for the delivery of television content, e.g., a broadcast server, a cable head-end, a video-on-demand (VoD) server, and so forth. For example, core network 150 may comprise a video super hub office, a video hub office and/or a service office/central office. For ease of illustration, various components of core network 150 are omitted from FIG. 1.

In one example, access networks 110 and 120 may each comprise a Digital Subscriber Line (DSL) network, a broadband cable access network, or the like. For example, access networks 110 and 120 may transmit and receive communications between endpoint devices 111-113, 121-123, and core network 150 relating to voice telephone calls, communications with web servers via the Internet 160, organization network 130, and so forth. Access networks 110 and 120 may also transmit and receive communications between endpoint devices 111-113, 121-123 and other networks and devices via Internet 160. Endpoint devices 111-113 and 121-123 may each comprise a telephone, e.g., for analog or digital telephony, a mobile device, a cellular smart phone, a laptop, a tablet computer, a desktop computer, a plurality or cluster of such devices, and the like. In some examples, endpoint devices 111-113 and 121-123 may connect to access networks 110 and 120 via one or more intermediate devices, such as a gateway and router, an Internet Protocol private branch exchange (IPPBX), and so forth. In one example, the access networks 110 and 120 may be different types of access networks. In another example, the access networks 110 and 120 may be the same type of access network. In one example, one or more of the access networks 110 and 120 may be operated by the same service provider operating core network 150.

In one example, access networks 110 and 120 may include a plurality of distribution areas (DAs). The distribution areas may include portions of access networks 110 and 120 associated with individual nodes (e.g., fiber optic nodes and/or digital subscriber line access multiplexers (DSLAMs)) and may serve multiple living units (LUs). The living units may include single family homes and businesses, as well as multi-dwelling units (MDUs). The distribution areas may be further associated with different wire centers and/or central offices (COs) (CLLI8) of the telecommunication network 105 and/or access networks 110 and 120. Each distribution area may be a portion of the telecommunication network 105 with fiber to the node (FTTN) or fiber to the curb (FTTC) already deployed (e.g., a hybrid fiber-coaxial (HFC) access network portion), or may comprise regions of the telecommunication network 105 with electrically wired trunks/routes from central offices to nodes (e.g., a DSL access network portion, etc.). In addition, distribution areas may be associated with either overhead utility wiring (aerial) or buried utility wiring (buried).

In one example, an organization network 130 may comprise a local area network (LAN), or a distributed network connected through permanent virtual circuits (PVCs), virtual private networks (VPNs), and the like for providing data and voice communications. In one example, the organization network 130 links one or more endpoint devices 131-134 with each other and with Internet 160, core network 150, devices accessible via such other networks, such as endpoint devices 111-113 and 121-123, and so forth. In one example, endpoint devices 131-134 may each comprise a telephone for analog or digital telephony, a mobile device, a cellular smart phone, a laptop, a tablet computer, a desktop computer, a bank or cluster of such devices, and the like. In one example, the organization network 130 may be associated with the telecommunication network 105. For example, the organization may comprise the telecommunication network service provider, where endpoint devices 131-134 of the organization network 130 may comprise devices of organizational agents, such as customer service agents, marketing personnel, or other employees or representatives who are tasked with addressing customer-facing issues and/or personnel for network maintenance, network repair, construction planning, field technician dispatch, and so forth.

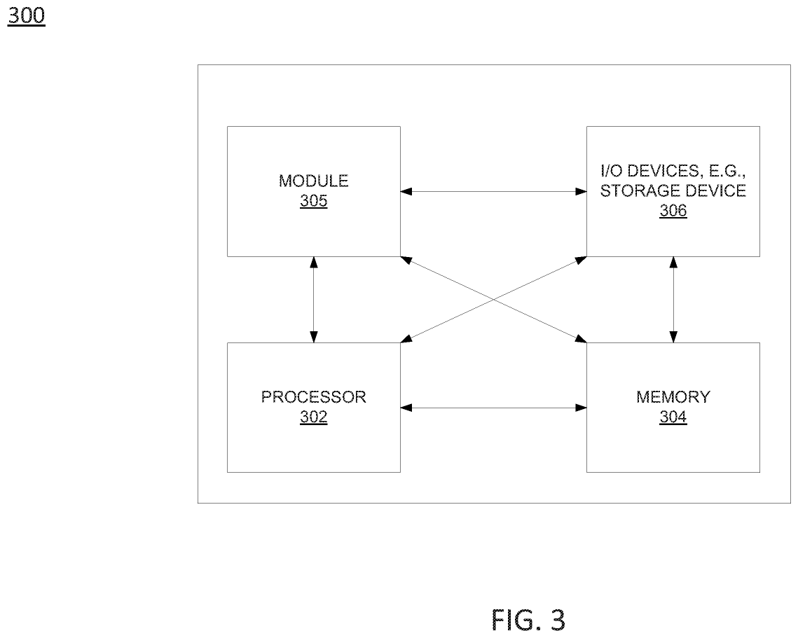

In one example, the system 100 may also include one or more servers 136 in the organization network 130. In one example, the servers 136 may each comprise a computing system, such as computing system 300 depicted in FIG. 3, and may be configured to host one or more centralized system components. It should be noted that in one example, a centralized system component may be hosted on a single server, while in another example, a centralized system component may be hosted on multiple servers, e.g., in a distributed manner. For example, a first centralized system component may comprise a database of customer/subscriber-assigned telephone numbers, while a second centralized system component may comprise a database of customer account data for all or a portion of the customers/subscribers of the telecommunication network 105. Other centralized system components may include a billing system, a customer relationship management (CRM) system, a trouble ticket system, an inventory system (IS), an ordering system, an enterprise reporting system (ERS), an account object (AO) database system, and so forth. In one example, any one or more of the centralized system components may comprise a set of file stores such as a Hadoop® Distributed File System (HDFS™) and/or another cloud/distributed network-based file storage system.

In one example, servers 136 may include a geodatabase and query system, e.g., PostGIS, CartoDB, ArcGIS, or the like, which may store shapefiles representing wire centers and/or distribution areas of portions of the telecommunication network. In one example, one of the servers 136 comprising a database and query system may further include CLLI information regarding different network equipment with various wire centers, central offices, distribution areas, etc. and/or customer demographic information. In one example, servers 136 may also include a field technician dispatch system for receiving work orders/job requests, e.g., for customer premises installation, repair, and maintenance jobs, for tracking assignments of work orders to field technicians and the statuses of different work orders, for interacting with dispatch agent devices (e.g., one of devices 131-134) to allow manual scheduling, assignment of work orders, etc., and so on. It should be noted that each work order in the dispatch system may relate to a respective customer appointment.

In one example, organization network 130 may also include an application server (AS) 135. In one example, AS 135 may comprise a computing system, such as computing system 300 depicted in FIG. 3, and may be configured to provide one or more functions for determining a plurality of opportunity windows for scheduling a new assignment for field technician work associated with a customer premises of a telecommunication network, in accordance with the present disclosure. For example, AS 135 may be configured to perform one or more steps, functions, or operations in connection with the example method 200 described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

To illustrate, application server 135 may generate from historical job feature data, historical calendar feature data, and historical times series data, a prediction model for predicting estimated durations of jobs of different job types. For example, one or more of the historical job feature data, historical calendar feature data, or historical time series data may be stored by and obtained from one of servers 136. In one example, the prediction model may comprise a linear combination of available features (historical data) and may be trained to learn weights to apply to the respective features. The prediction model may comprise, for example, a gradient boosted machine. In addition, the prediction model may be applied to new data as an input (e.g., data relating to a scheduled/pending customer assignment) to provide an output of an estimated job duration which may be used in the operations described above for generating a hypothetical schedule.

Similarly, application server 135 may generate from field technician work history information a prediction model for predicting estimate numbers of field technicians available to work on particular future dates. For example, the field technician work history information may be stored by and obtained from one of servers 136. In one example, the prediction model may comprise a linear combination of available features (historical data) and may be trained to learn weights to apply to the respective features. The prediction model may comprise, for example, a gradient boosted machine. In addition, the prediction model may be applied to new data as an input (e.g., data relating to the future date for which a hypothetical schedule is being generated) to provide an output of an estimated number of field technicians available to work on the future date.

It should be noted that in other, further, and different examples, the present disclosure may alternatively or additionally train various types of machine learning algorithms (MLAs) from historical job feature data, historical calendar feature data, and historical time series data to generate machine learning models (MLMs)/predictive models for predicting a duration of a customer assignment of a particular customer assignment/job type, or may train MLAs from historical field technician work history information to generate MLMs/predictive models for predicting an estimated number of field technicians available to work on a future date, such as support vector machines (SVMs), e.g., linear or non-linear binary classifiers, multi-class classifiers, deep learning algorithms/models, decision tree algorithms/models, k-nearest neighbor (KNN) clustering algorithms/models, and so forth.

In one example, application server 135 may also obtain a request for a new assignment for field technician work associated with a customer premises of a telecommunication network. The request may be received from one of endpoint devices 111-113 and 121-123 (e.g., a customer device) and may relate to a customer premises associated with the respective one of the endpoint devices 111-113 and 121-123. Application server 135 may generate a hypothetical schedule for a future date for a plurality of field technicians from a set of scheduled assignments. The hypothetical schedule may be generated in accordance with a plurality of optimization factors and/or constraints, as described above. For example, application server 135 may obtain and/or calculate estimated durations of jobs of different job types and may obtain a set of currently scheduled customer appointments for the future date. For example, application server 135 may obtain data regarding a pending/scheduled customer assignments from various servers 136. For instance, one of servers 136 may comprise a field technician dispatch system maintaining information regarding pending/requested customer assignments. The hypothetical schedule may be generated on an ongoing basis or in response to the obtaining of the request. In one example, the hypothetical schedule may include a plurality of bundles of scheduled assignments for field technician work for the plurality of field technicians, where each bundle includes a plurality of scheduled assignments for an individual field technician of the plurality of field technicians for the future date.

Application server 135 may then determine a plurality of opportunity windows for scheduling the new assignment, where the plurality of opportunity windows comprises time blocks during the future date for which individual field technicians of the plurality of field technicians are not scheduled to work one of the plurality of scheduled assignments in a respective bundle of the plurality of bundles in accordance with the hypothetical schedule for the future date. The application server 135 next may rank the plurality of opportunity windows in accordance with a second plurality of optimization factors, and provide an offer of at least one of the plurality of opportunity windows, e.g., to the customer via one of endpoint devices 111-113 and 121-123, where the offer includes at least one rank of the at least one of the plurality of opportunity windows. In addition, application server 135 may monitor customer assignment completions (e.g., receiving indications of whether the customer assignments are completed, the durations/times to complete different customer assignments of different job types/customer assignment types, and so forth), may update the prediction model(s) in accordance with the actual outcomes of the customer assignments, and so on.

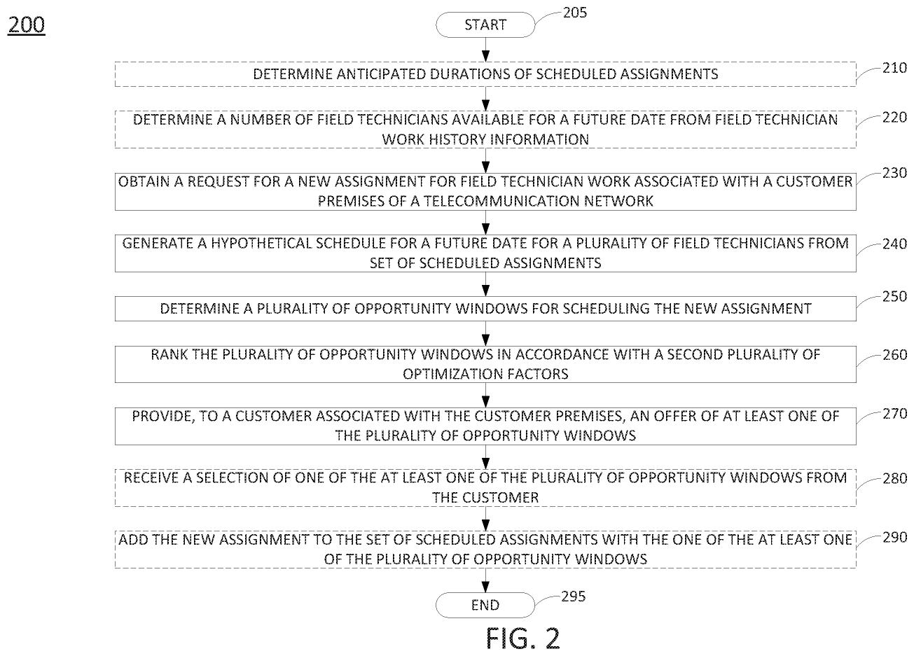

These and other example operations for determining a plurality of opportunity windows for scheduling a new assignment for field technician work associated with a customer premises of a telecommunication network are described in greater detail below in connection with the example of FIG. 2. In addition, it should be realized that the network 100 may be implemented in a different form than that illustrated in FIG. 1, or may be expanded by including additional endpoint devices, access networks, network elements, application servers, etc. without altering the scope of the present disclosure.

FIG. 2 illustrates a flowchart of an example method 200 for determining a plurality of opportunity windows for scheduling a new assignment for field technician work associated with a customer premises of a telecommunication network. In one example, the method 200 is performed by a component of the system 100 of FIG. 1, such as by application server 135, and/or any one or more components thereof (e.g., a processor, or processors, performing operations stored in and loaded from a memory), or by application server 135, in conjunction with one or more other devices, such as servers 136, and so forth. In one example, the steps, functions, or operations of method 200 may be performed by a computing device or system 300, and/or processor 302 as described in connection with FIG. 3 below. For instance, the computing device or system 300 may represent any one or more components of application server 135, one or more of servers 136, etc. in FIG. 1 that is/are configured to perform the steps, functions and/or operations of the method 200. Similarly, in one example, the steps, functions, or operations of method 200 may be performed by a processing system comprising one or more computing devices collectively configured to perform various steps, functions, and/or operations of the method 200. For instance, multiple instances of the computing device or processing system 300 may collectively function as a processing system. For illustrative purposes, the method 200 is described in greater detail below in connection with an example performed by a processing system.

The method 200 begins at step 205 and proceeds to step 210.

At optional step 210, the processing system may determine anticipated durations of scheduled assignments (e.g., for field technician work associated with customer premises of a telecommunication network), where the scheduled assignments include a plurality of different types of assignments. For example, the anticipated durations may be determined via a prediction model, e.g., a gradient boosted machine, using historical job feature data of historical customer assignments as training/input data. The historical job feature data may comprise any of the types of job feature data mentioned above. For instance, for each of the historical customer assignments, the historical job feature data may include a time to complete the historical customer assignment and at least one additional feature of: a category of work, a type of work, a type of network associated with the work, a geographic identifier of an area for the work, a priority level for the work, a status of the work, or a due date for completion of the work. In one example, the prediction model is a linear function of these feature values, and the weights for each feature may be learned by the prediction model. In one example, the prediction model (e.g., a gradient boosted machine) regresses the at least one additional feature of the historical customer assignments to respective times to complete the historical customer assignment. In one example, the prediction model further uses historical calendar feature data and historical time series feature data as training/input data. For instance, optional step 210 may further include regressing these features to completion durations for customer assignments (e.g., in addition to the historical job feature data). The historical calendar feature data and historical time series feature data may comprise any of the types of calendar feature data and time series feature data mentioned above.

At optional step 220, the processing system may determine a number of the field technicians available for the future date from field technician work history information. In one example, the number of field technicians available for the future date is determined via a prediction model (e.g., a gradient boosted machine) using the historical field technician work history information as input/training data. The historical field technician work history information may comprise, for each day of a plurality of days associated with the historical field technician work history information, an actual number of technicians working the day and at least one additional feature of: a day of a week, a week of a month, a month, an indication of a holiday or a non-holiday, an indication of a weekday or a weekend, a number of field technicians scheduled to work, or a mean count of field technicians assigned to an area. In one example, the gradient boosted machine regresses the at least one additional feature of each day of the plurality of days associated with the historical field technician work history information to the actual number of technicians working each data of the plurality of days. In one example, the prediction model is a linear function of these feature values, and the weights for each feature may be learned by the prediction model. For instance, the prediction model (e.g., the gradient boosted machine) may regress features about each type of day (e.g., weekday, weekend, specific day of the week, month of the year, week in the month, holiday, non-holiday, etc.) to the actual number of technicians working that day.

At step 230, the processing system obtains a request for a new assignment for field technician work associated with a customer premises of a telecommunication network. In one example, step 230 may include obtaining a preference of a customer associated with the customer premises for a time for the new assignment. In another example, the processing system may obtain the customer preference from a stored customer profile, or may have saved a preference from a past customer assignment. The preference may comprise a preference for at least one of: a morning, an afternoon, a weekday, a weekend, a particular day of the week, or a particular date.

At step 240, the processing system generates a hypothetical schedule for a future date for a plurality of field technicians from a set of scheduled assignments. In one example, the hypothetical schedule includes a plurality of bundles of scheduled assignments for field technician work for the plurality of field technicians, where each bundle includes a plurality of scheduled assignments for an individual field technician of the plurality of field technicians for the future date. In one example, the hypothetical schedule is generated in accordance with a first plurality of optimization factors. For instance, the first set of optimization factors may comprise at least one of: a preference to assign all scheduled assignments to available field technicians, a preference to use as few field technicians as possible, a preference to have individual field technicians work at most a designated number of hours in a day (e.g., eight hours, seven hours, nine hours, etc.), or a preference to minimize driving distances by the plurality of field technicians. In another example, the first set of optimization factors may include a preference to average a number of hours assigned to work over all available field technicians.

In one example, the hypothetical schedule is further generated in accordance with a plurality of constraints associated with the scheduled assignments of the set of scheduled assignments, such as locations of the scheduled assignments and anticipated durations of the scheduled assignments. In one example, the anticipated durations of the scheduled assignment may be determined at optional step 210 as described above. In one example, the plurality of constraints may further comprise at least one of: starting points of the plurality of field technicians, types of work for the scheduled assignments, or skill sets of the plurality of field technicians. In one example, the processing system takes into account the set of scheduled assignments, the locations of the assignments, the field technicians' starting locations, the types for the assignments (e.g., service type, network type, install vs. maintenance, etc.), the anticipated durations of the assignments (e.g., for different types of assignments), the field technicians' skill sets (e.g., available field technicians to work specific types of assignments), and so forth.

At step 250, the processing system determines a plurality of opportunity windows for scheduling the new assignment, where the plurality of opportunity windows comprises time blocks during the future date for which individual field technicians of the plurality of field technicians are not scheduled to work one of the plurality of scheduled assignments in a respective bundle of the plurality of bundles in accordance with the hypothetical schedule for the future date.

At step 260, the processing system ranks the plurality of opportunity windows in accordance with a second plurality of optimization factors. For example, the second set of optimization factors may comprise at least one of: a preference to minimize a distance between a prior assignment in a bundle and the new assignment, if the new assignment were to be scheduled in an opportunity window after the prior assignment, a preference to fulfill a preference of a customer for a time for the new assignment, or a preference to favor that the new assignment be assigned to a bundle for a field technician that is already assigned at least one other assignment for the future date.

At step 270, the processing system provides, to a customer associated with the customer premises, an offer of at least one of the plurality of opportunity windows, where the offer includes at least one rank of the at least one of the plurality of opportunity windows.

At optional step 280, the processing system may receive a selection of one of the at least one of the plurality of opportunity windows from the customer (e.g., from an endpoint device of the customer).

At optional step 290, the processing system may add the new assignment to the set of scheduled assignments with the one of the at least one of the plurality of opportunity windows. For additional new customer assignments, the new assignment may be accounted for by updating a hypothetical schedule for the day for which the new assignment has been reserved in accordance with the customer's selection at optional step 280.

Following step 270, or either of optional steps 280-290, the method 200 proceeds to step 295 where the method ends.

It should be noted that the method 200 may be expanded to include additional steps, or may be modified to replace steps with different steps, to combine steps, to omit steps, to perform steps in a different order, and so forth. For instance, in one example the processor may repeat one or more steps of the method 200, such as steps 230-270, steps 210-270, steps 210-290, and so forth. In another example, the processing system may update the prediction models of optional step 210 and/or 220, or update an optimizer implemented at step 240 in accordance with outcomes of pending customer assignments as the assignments are completed (or the scheduled time slots have passed). Thus, these and other modifications are all contemplated within the scope of the present disclosure.

In addition, although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 3 depicts a high-level block diagram of a computing device or processing system specifically programmed to perform the functions described herein. For example, any one or more components or devices illustrated in FIG. 1 or described in connection with the method 200 may be implemented as the processing system 300. As depicted in FIG. 3, the processing system 300 comprises one or more hardware processor elements 302 (e.g., a microprocessor, a central processing unit (CPU) and the like), a memory 304, (e.g., random access memory (RAM), read only memory (ROM), a disk drive, an optical drive, a magnetic drive, and/or a Universal Serial Bus (USB) drive), a module 305 for determining a plurality of opportunity windows for scheduling a new assignment for field technician work associated with a customer premises of a telecommunication network, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for determining a plurality of opportunity windows for scheduling a new assignment for field technician work associated with a customer premises of a telecommunication network (e.g., a software program comprising computer-executable instructions) can be loaded into memory 304 and executed by hardware processor element 302 to implement the steps, functions or operations as discussed above in connection with the example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for determining a plurality of opportunity windows for scheduling a new assignment for field technician work associated with a customer premises of a telecommunication network (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor, a request for a new assignment for field technician work associated with a customer premises of a telecommunication network;
generating, by the processing system, a hypothetical schedule for a future date for a plurality of field technicians from a set of scheduled assignments, wherein the hypothetical schedule includes a plurality of bundles of scheduled assignments for field technician work for the plurality of field technicians, wherein each bundle includes a plurality of scheduled assignments for an individual field technician of the plurality of field technicians for the future date, wherein the hypothetical schedule is generated in accordance with a first plurality of optimization factors;
determining, by the processing system, a plurality of opportunity windows for scheduling the new assignment, wherein the plurality of opportunity windows comprises time blocks during the future date for which individual field technicians of the plurality of field technicians are not scheduled to work one of the plurality of scheduled assignments in a respective bundle of the plurality of bundles in accordance with the hypothetical schedule for the future date;
ranking, by the processing system, the plurality of opportunity windows in accordance with a second plurality of optimization factors; and
providing, by the processing system to a customer associated with the customer premises, an offer of at least one of the plurality of opportunity windows, wherein the offer includes at least one rank of the at least one of the plurality of opportunity windows.

2. The method of claim 1, further comprising:
receiving a selection of one of the at least one of the plurality of opportunity windows from the customer; and
adding the new assignment to the set of scheduled assignments with the one of the at least one of the plurality of opportunity windows.

3. The method of claim 1, wherein the first set of optimization factors comprises at least one of:
a preference to assign all scheduled assignments to available field technicians;
a preference to use as few field technicians as possible;
a preference to have individual field technicians work at most a designated number of hours in a day; or
a preference to minimize driving distances by the plurality of field technicians.

4. The method of claim 1, wherein the hypothetical schedule is further generated in accordance with a plurality of constraints associated with the scheduled assignments of the set of scheduled assignments.

5. The method of claim 4, wherein the plurality of constraints comprises:
locations of the scheduled assignments; and
anticipated durations of the scheduled assignments.

6. The method of claim 5, further comprising:
determining the anticipated durations of the scheduled assignments, wherein the scheduled assignments include a plurality of different types of assignments.

7. The method of claim 6, wherein the anticipated durations are determined via a gradient boosted machine using historical job feature data of historical customer assignments as training data.

8. The method of claim 7, wherein for each of the historical customer assignments, the historical job feature data comprises a time to complete the historical customer assignment and at least one additional feature of:
a category of work;
a type of work;
a type of network associated with the work;
a geographic identifier of an area for the work;
a priority level for the work;
a status of the work; or
a due date for completion of the work.

9. The method of claim 8, wherein the gradient boosted machine regresses the at least one additional feature of the historical customer assignments to respective times to complete the historical customer assignments.

10. The method of claim 7, wherein the anticipated durations are determined via the gradient boosted machine further using historical calendar feature data and time series feature data as the training data.

11. The method of claim 5, wherein plurality of constraints further comprises at least one of:
starting points of the plurality of field technicians;
types of work for the scheduled assignments; or
skill sets of the plurality of field technicians.

12. The method of claim 1, wherein the obtaining the request includes obtaining a preference of the customer associated with the customer premises for a time for the new assignment.

13. The method of claim 12, wherein the preference comprises a preference for at least one of:
a morning;
an afternoon;
a weekday;
a weekend;
a particular day of the week; or
a particular date.

14. The method of claim 1, wherein the second set of optimization factors comprises at least one of:
a preference to minimize a distance between a prior assignment in a bundle and the new assignment, if the new assignment were to be scheduled in an opportunity window after the prior assignment;
a preference to fulfill a preference of a customer for a time for the new assignment; or
a preference to favor that the new assignment be assigned to a bundle for a field technician that is already assigned at least one other assignment for the future date.

15. The method of claim 1, further comprising:
determining a number of the field technicians available for the future date from field technician work history information.

16. The method of claim 15, wherein the number of field technicians available for the future date is determined via a gradient boosted machine using historical field technician work history information as training data.

17. The method of claim 16, wherein the historical field technician work history information comprises, for each day of a plurality of days associated with the historical field technician work history information, an actual number of technicians working the day and at least one additional feature of:
a day of a week;
a week of a month;
a month;
an indication of a holiday or a non-holiday;
an indication of a weekday or a weekend;
a number of field technicians scheduled to work; or
a mean count of field technicians assigned to an area.

18. The method of claim 17, wherein the gradient boosted machine regresses the at least one additional feature of each day of the plurality of days associated with the historical field technician work history information to the actual number of technicians working each data of the plurality of days.

19. A non-transitory computer-readable medium storing instructions which, when executed by a processing system including at least one processor, cause the processing system to perform operations, the operations comprising:
obtaining a request for a new assignment for field technician work associated with a customer premises of a telecommunication network;
generating a hypothetical schedule for a future date for a plurality of field technicians from a set of scheduled assignments, wherein the hypothetical schedule includes a plurality of bundles of scheduled assignments for field technician work for the plurality of field technicians, wherein each bundle includes a plurality of scheduled assignments for an individual field technician of the plurality of field technicians for the future date, wherein the hypothetical schedule is generated in accordance with a first plurality of optimization factors;
determining a plurality of opportunity windows for scheduling the new assignment, wherein the plurality of opportunity windows comprises time blocks during the future date for which individual field technicians of the plurality of field technicians are not scheduled to work one of the plurality of scheduled assignments in a respective bundle of the plurality of bundles in accordance with the hypothetical schedule for the future date;
ranking the plurality of opportunity windows in accordance with a second plurality of optimization factors; and
providing, to a customer associated with the customer premises, an offer of at least one of the plurality of opportunity windows, wherein the offer includes at least one rank of the at least one of the plurality of opportunity windows.

20. A device comprising:
a processor system including at least one processor; and
a computer-readable medium storing instructions which, when executed by the processing system, cause the processing system to perform operations, the operations comprising:
obtaining a request for a new assignment for field technician work associated with a customer premises of a telecommunication network;
generating a hypothetical schedule for a future date for a plurality of field technicians from a set of scheduled assignments, wherein the hypothetical schedule includes a plurality of bundles of scheduled assignments for field technician work for the plurality of field technicians, wherein each bundle includes a plurality of scheduled assignments for an individual field technician of the plurality of field technicians for the future date, wherein the hypothetical schedule is generated in accordance with a first plurality of optimization factors;
determining a plurality of opportunity windows for scheduling the new assignment, wherein the plurality of opportunity windows comprises time blocks during the future date for which individual field technicians of the plurality of field technicians are not scheduled to work one of the plurality of scheduled assignments in a respective bundle of the plurality of bundles in accordance with the hypothetical schedule for the future date;
ranking the plurality of opportunity windows in accordance with a second plurality of optimization factors; and
providing, to a customer associated with the customer premises, an offer of at least one of the plurality of opportunity windows, wherein the offer includes at least one rank of the at least one of the plurality of opportunity windows.
